(19) United States
(12) Patent Application Publication
(10) Pub. No.: US 2005/0135385 A1
(43) Pub. Date: Jun. 23, 2005

(54) Method and apparatus for digital cross connect

(75) Inventors: David W. Jenkins, North Aurora, IL (US); Mark A. Bremner, Barrington, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 10/738,911

(22) Filed: Dec. 17, 2003

(51) Int. Cl. H04L 12/28

(52) U.S. Cl. 370/401; 370/386

(57) ABSTRACT

A digital cross connect includes a first transport switch that grooms inbound traffic for at least one local switch and a second transport switch that grooms outbound traffic for the local switch(es). The transport switches may operate independently. The local switch(es) may be protocol switches. The digital cross connect may be deployed in a central office in an electrical, optical, or wireless network.

### BACKGROUND OF THE INVENTION

In a communications network, data traffic is generally sent to central offices, sometimes referred to as “hubs,” that are collection points in the network. Traffic at these hubs must be groomed for distribution to various switches, such as voice switches, Internet Protocol (IP) switches, Asynchronous Transfer Mode (ATM) switches, Frame Relay (FR) switches, and others. Upon return from a switch, the traffic must be re-groomed for distribution to other points in the network. This results in a need for large capacity transport switches or cross connects that are designed to groom low speed traffic within high speed traffic trunks.

As traffic grows in the network, the requirements of the cross connect grow, and the network element must grow in size. At some point, the cross connect reaches a limit in capacity. To satisfy the grooming needs of the network, a second cross connect must be added. When the new cross connect is added, there are trunks required between the new and the old cross connects. These trunks, referred to as “tandem ties”, allow enough connectivity to effectively groom the traffic. These tandem ties can consume 20 to 25% of the capacity of each of the cross connects and increase the total capital cost.

### SUMMARY OF THE INVENTION

A digital cross connect in accordance with the principles of the present invention adds cross connect capacity without using tandem ties. The digital cross connect grooms inbound traffic at a first transport switch for at least one local switch and grooms outbound traffic at a second transport switch for the local switch(es).

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram in which the principles of the present invention are employed in hubs;

FIG. 2 is a block diagram of hubs in the network of FIG. 1 that each groom inbound traffic and outbound traffic separately for their local switch(es); and

FIG. 3 is a detailed block diagram of a hub in FIG. 2.

### DETAILED DESCRIPTION OF THE INVENTION

A description of preferred embodiments of the invention follows.

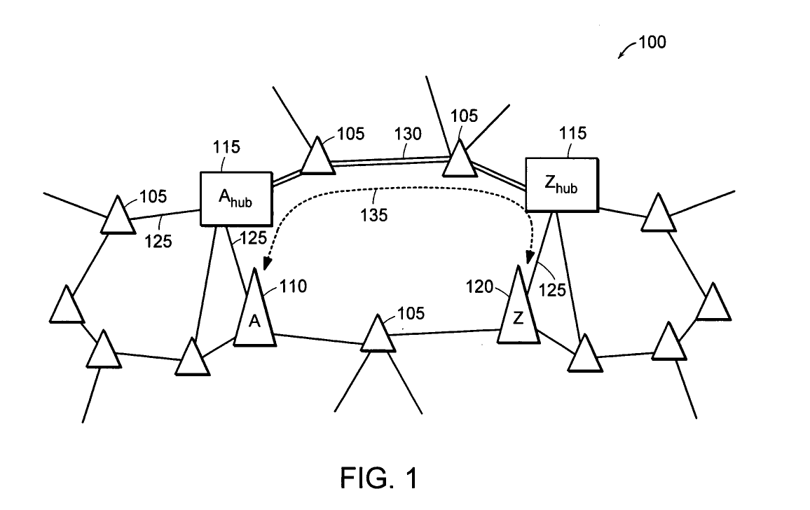

FIG. 1 is an example network 100 in which an embodiment of the present invention may be employed. In the example network 100, Central Offices (CO's) 105, 110, 115, 120 communicate via electrical, optical, or wireless communications links or pipes 125, 130. The central offices 105, 110, 115, 120, may be referred to as nodes, and large central offices may be referred to as “hubs.” In this example network 100, the two central offices 115 that are larger in size than the other central offices 105, 110, 120 are examples of hubs. Transport and protocol switches (not shown) are typically available in large central offices 115.

In accordance with the principles of the present invention, two or more cross connects can be used in a service provider's central office without a need for tandem ties. At least one of the tandem ties grooms inbound data traffic to local switch(es), and another grooms outbound traffic from the local switches to the rest of the network.

In operation, node A 110 may transmit/receive traffic to/from node Z 120. Communication from node A 110 to node Z 120 takes a path 135 through the hubs 115 over pipes 125, 130. High-speed pipes or “trunks” 130 (shown in thick lines) support traffic at high data rates, such as OC-48 (2.4 Gbps) or OC-192 (10 Gbps). Low-speed pipes 125 (shown in thin lines) support traffic at lower data rates, such as T0 (64 Kb) or OC-3 (155 Mbps).

Transport switches (not shown) located within the hubs 115 perform “traffic grooming,” which is a term used to describe how a number of different (lower speed) traffic streams (e.g., OC-3, OC-12, etc.) are packed into a higher-speed stream (e.g., OC-48, OC-192). A transport switch may be employed to handle traffic on each side of the pipes 125, 130. Protocol switches (not shown) can determine (i) destinations of individual traffic elements in a packet-switch network, or (ii) connections to other nodes in a circuit-switching network. Protocol switches can selectively forward traffic to the destination computer. For purposes of describing this invention, the operation of the transport and protocol switches is unimportant. It is the arrangement among the transport and protocol switches that is important.

Communications links between network nodes are presently found in two hierarchical forms: (i) Plesiochronous Digital Hierarchy (PDH), which is not quite synchronous and not quite asynchronous, is electrical, well established, and allows transport to central offices; and (ii) Synchronous Optical Network (SONET) hierarchy, which is optical, evolved in the 1990's, and provides transport from central office to central office. In the PDH hierarchy, a T0 is a 64 Kb line (i.e., a standard phone line) and sometimes referred to by its digital equivalent DS0; T1 can carry 24 T0's bundled together (DS1); and T3 can carry 28 T1's bundled together (DS3). In the SONET hierarchy, Optical Carrier (3) (OC3) can carry 3 T3's bundled together; OC12 can carry 12 T3's bundled together; OC 48 can carry 48 T3's bundled together; and OC 192 can carry 192 T3's bundled together. SONET network elements generally have not supported T0's or T1's. Traffic at these lower levels is groomed for high speed transport and, at points in the network, is re-groomed for transport at their native levels.

Examples of grooming capabilities for various devices are as follows: SONET Add-Drop Multiplexers (ADMs) groom DS3 through OC-48 into one optical signal (OC-48 or OC-192) for transport. SONET broadband digital cross connects groom DS3s through OC-48 into many optical signals (OC-48 or OC-192) for transport. Wideband digital cross connects groom many DS1's into many DS3's and has ports from DS-1 through OC-48. Narrowband digital cross connects groom many DS0's into many DS1's and has ports from DS0 through DS3.

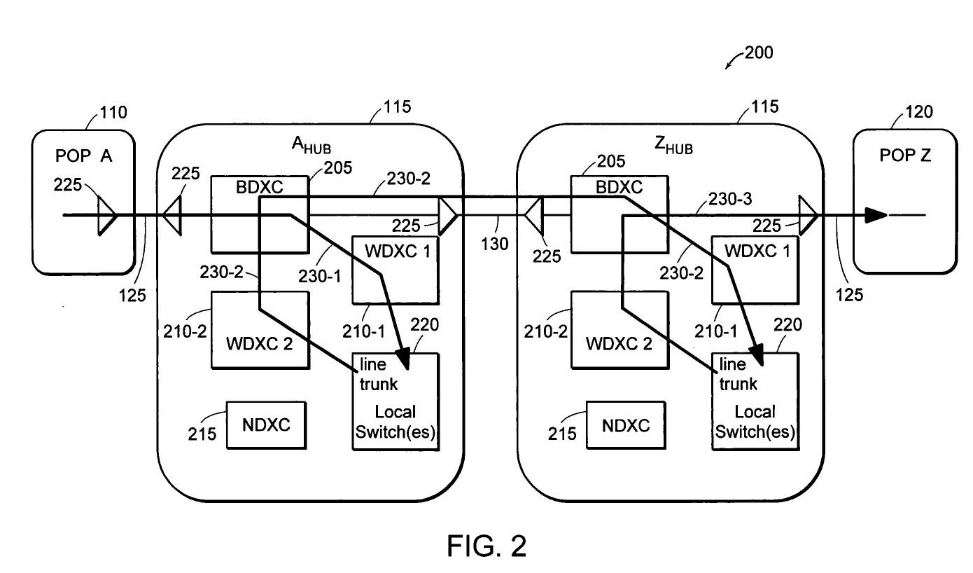

FIG. 2 is a network diagram of a subset 200 of the network 100 of FIG. 1 that includes the central offices 110, 120 and hubs 115. The central offices 110, 120 are referred to here as Points of Presence (POPs) 110, 120. Each of the POPs 110, 120 includes an Add-Drop Multiplexer (ADM) 225. The hubs 115 also include ADMs 225. This allows the POPs 110, 120 and hubs 115 to exchange communications across the communications links 125, 130.

The hubs 115, in this example, also include Broadband Digital Cross Connects (BDXC) 205, Wideband Digital Cross Connects (WDXC) 210-1, 210-2, and Narrowband Digital Cross Connects (NDXC) 215. A digital Cross Connect is sometimes referred to as Digital Cross-Connect System (DCS). The digital cross connects 205, 210, and 215 may also be referred to as transport switches since they manage traffic flow over the pipes 125, 130 of the network 100.

Traffic that flows over the pipes 125, 130 can be of a variety of traffic protocols, such as voice, Internet Protocol (IP), Asynchronous Transfer Mode (ATM), Frame Relay (FR), and others. The traffic of a particular protocol type must be switched by a network element of that type somewhere in each network it traverses. For example, voice traffic must connect to a voice switch. The voice switch sets up the phone connections that enable a phone call. Similar connections are set up by other types of switches. In the hubs 115 of FIG. 2, the protocol switches that handle the traffic are more generally referred to as local switches 220 and can be switches other than the example protocol switches shown, including non-protocol switches.

The communications path 135 between nodes A and Z in FIG. 1 is shown more particularly in FIG. 2 as paths going to the local switches 220 and paths going away from the local switches 220. In both hubs 115, one WDXC 210-1 performs inbound grooming (i.e., separating high-speed traffic streams into comparable lower speed traffic streams) for the local switches 220, and the other WDXC 210-2 performs the outbound grooming (i.e., packing the lower speed traffic streams into higher speed traffic streams) for the local switches 220.

By separating the inbound grooming and outbound grooming functions into separate transport switches, higher capacity can be achieved. For example, a typical WDXC 210 has a capacity of 3000 ports, where about 1500 inbound/outbound ports can be used in a tandem tie configuration. In contrast, using the principles of the present invention, (i) 3000 inbound ports are available to the local switches 220 or (ii) 3000 outbound ports are available to the local switches 220. Therefore, in this example, the principles of the present invention allow for twice the capacity over hubs 115 that use tandem ties between the transport switches 210.

In operation with respect to FIG. 2, traffic is transported from node A 110 to node Z 120 and must travel through the associated hubs 115. The traffic is just added together or “muxed” of various protocols at node A 110. At the hub 115, the DS1's and DS0's of different protocols must be removed and sent to the appropriate switches 220. This is done first with either the BDXC 205 or ADM 225 and patch panels and then with the first WDXC 210-1. The traffic comes back from the local switches 220 to the second transport switch 210-2 to be groomed for transport to the other hub 115. Thus, there are two grooming functions at each hub 115, where one transport switch (e.g., WDXC 210) is used to perform inbound grooming and the other outbound grooming.

Continuing to refer to FIG. 2 in more detail, both of the hubs 115 have their first WDXC 210-1 configured to groom inbound traffic for the local switch(es) 220 and their second wideband digital cross connects 210-2 configured to groom outbound traffic for the local switch(es) 220. So, for example, for traffic traveling from POP A 110 to POP Z 120, the traffic travels through the first WDXC 210-1 to the local switch(es) 220 and from the local switch(es) 220 through the second WDXC 210-2. The paths taken in this traffic flow begin in a first path 230-1 to the hub A local switches 220, continue from the hub A local switches 220 in a second path 230-2 to the hub Z local switches 220, and continues in a third path 230-3 from the hub Z local switches 220 to POP Z 120.

For traffic traveling from POP Z 120 to POP A 110, the traffic travels in the reverse direction from traffic flowing from POP A 110 to POP Z 120. In the reverse direction, the traffic travels from POP Z 120 to the local switches 220 in hub Z 115 via the BDXC 205 and WDXC 210-1. From the local switches 220 in hub Z 115, the traffic flows outbound through the WDXC 210-2 and BDXC 205 to hub A 115 via the ADMs 225 and associated trunk 130. In hub A, 115, the transport switch 210-1 that grooms the inbound traffic for the local switches 220 receives the traffic from hub Z 115 via the BDXC 205, and the other transport switch WDXC 210-2 grooms the outbound traffic for the local switches 220 and forwards it through the BDXC 205 for transmission via the ADMs 225 and associated path 125 to POP A 110.

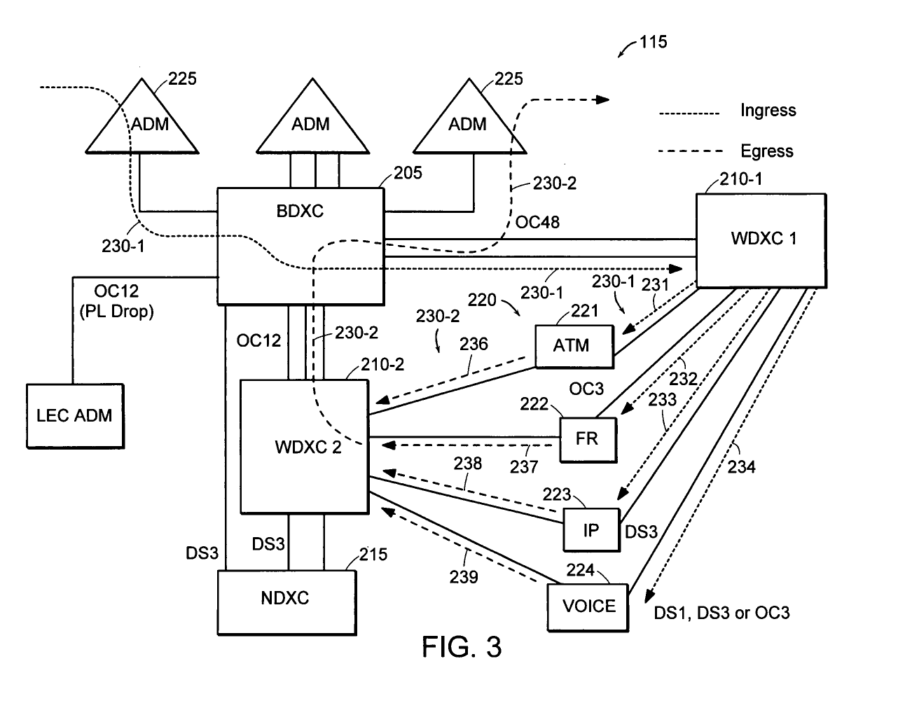

FIG. 3 is a block diagram of one of the hubs 115 with more detail with respect to the local switches 220. The first path 230-1, referred to here as the ingress path 230-1, is expanded (i.e., may take different routes) following receipt by the first WDXC 210-1 that grooms the inbound traffic for the local switches 220. Specifically, the ingress path 230-1 that the inbound traffic follows is expanded into four different paths 231, 232, 233, and 234. Each of these paths 231-234 may be independently connected between the WDXC 210-1 and a respective switch 221, 222, 223, or 224.

Similarly, the second path 230-2, referred to here as the egress path 230-2, has four different paths 236-239 that extend from the switches 221-224 to the second WDXC 210-2. Beyond the second transport switch 210-2, the egress path 230-2 is as described above.

Between the receiving ADM 225 and BDXC 205, the traffic may be OC-48 or OC-192. If OC-192, in this example, the BDXC 205 grooms the OC-192 for transmission to the inbound grooming transport switch 210-1 as OC-48 traffic. Other WDXC's (not shown) may be used in parallel to support the OC-192 rate. The inbound transport switch 210-1 grooms the OC-48 traffic into different forms of lower bandwidth signals for the different protocol switches 220. For example, the first transport switch 210-1 provides (i) an OC-3 signal for the ATM 221, (ii) a DS1 signal for the Frame Relay (FR) 222, (iii) a DS3 signal for the IP switch 223, and (iv) a DS1, DS3, or OC-3 signal for the voice switch 224. Similar protocols are supported between the local switches 220 and the second transport switch 210-2 along the respective links 236-239. The protocol switches 221-224 extract the payloads from the signals and transmit in the respective protocols to other nodes (not shown).

The grooming of inbound and outbound traffic may be performed independently at the first transport switch 210-1 and second transport switch 210-2. In other words, there may be no communications or tandem ties between the transport switches 210. The protocol switches 220 may be configured manually, locally or remotely, or automatically to know which of the transport switches 210-1 or 210-2 is configured to groom the inbound traffic and which is configured to groom the outbound traffic.

Although grooming traffic has only been discussed with respect to two transport switches 210-1, 210-2, three or more transport switches may be used to perform traffic grooming or non-traffic grooming. Additionally, although the transport switches performing the grooming has been discussed with respect to the WDXCs 210, it should be understood that any of the transport switches (i.e., the BDXC 205, WDXC 210, or NDXC 215) may be used to groom the inbound or outbound traffic for the local switches 220 within their data rate capacities.

As should be understood, the principles of the present invention may be used in electrical, optical, wireless, or combination electrical/optical/wireless networks.

While this invention has been particularly shown and described with references to preferred embodiments thereof, it will be understood by those skilled in the art that various changes in form and details may be made therein without departing from the scope of the invention encompassed by the appended claims.

For example, the two transport switches 210-1, 210-2 may be located in the hubs 115, as shown and described in reference to FIGS. 2 and 3, external from the hubs 115, or one internal and one external. In such an embodiment, the transport switch 220-1 performing the inbound grooming continues to perform the inbound grooming for the local switches 220, and the transport switch 220-2 performing the outbound grooming continues to perform the outbound grooming for the local switches 220.

As another example, the broadband transport switch BDXC 205 of FIGS. 2 and 3 that transmits and receives the groomed wideband traffic to/from the WDXC's 210-1, 210-2, respectively, may perform other functions in other embodiments. For instance, in one embodiment, the BDXC 205 may not be used in the hubs 115, and traffic may go directly to/from the WDXC's 210-1, 210-2 to nodes external from the hubs 115. The hubs 115 may include at least two BDXC's 205, where at least one BDXC 205 performs inbound grooming and at least one BDXC 205 performs outbound grooming for the local switches 220, similar to the grooming functions described above in reference to the WDXC's 210-1, 210-2.

As a further example, there may be at least two NDXC's 215 in the hubs 115 of FIGS. 2 and 3. In such a case, at least one NDXC 215 performs inbound grooming and at least one NDXC 215 performs outbound grooming for the local switches 220.

Yet another example includes an embodiment in which a dynamically allocated hierarchical arrangement of the transport switches 205, 210, and 215 is deployed. In this embodiment, the transport switches 205, 210, and 215 are arranged to groom inbound and outbound traffic in a hierarchical or non-hierarchical manner. This means that traffic to and from the local switches 220 can take paths to any of the transport switches 205, 210, or 215 directly or hierarchically (i.e., highest bandwidth to lowest bandwidth when going to the local switches 220 and lowest bandwidth to highest bandwidth when transmitted from the local switches 220). In this embodiment, the transport switches 205, 210, 215 and local switches 220 share information as determine the traffic flow. For instance, in the outbound direction, grooming traffic may be most optimized when the traffic flows from the local switches 220 to a narrow band transport switch, NDXC 215, for a first grooming; from the narrow band transport switch 215 to a wideband transport switch, WDXC 210-2, for a second grooming; and from the wideband transport switch 210-2 to a broadband transport switch, BDXC 205, for a third grooming. In cases where the transport switches identify extraneous space in the higher band traffic exists, but not enough space to fit traffic of a “next lower size,” the outbound grooming BDXC 205 may send information to the outbound grooming NDXC 215 and local switches 220 to forward traffic directly to it instead of the outbound grooming WDXC 210-2 for optimized usage of its grooming function.

In the case of the FIGS. 2 and 3 embodiment or the dynamically allocated hierarchical embodiment just described, the transport switches 205, 210, 215 may also provide inbound and outbound grooming function support in accordance with the principles of the present invention for local switches 220 that are external from the hubs 115 in which the transport switches 205, 210, 215 reside.

It should be understood that the foregoing combinations provide added cross connect capacity without the need for tandem ties. It should also be understood that there may be automatic or manual configuration steps performed to provide for the inbound and outbound grooming functions in accordance with the principles of the present invention.

1. A method for grooming network traffic in a digital cross connect, comprising: grooming inbound traffic at a first transport switch for at least one local switch; and grooming outbound traffic at a second transport switch for the at least one local switch.

2. The method according to claim 1 wherein the grooming of inbound and outbound traffic is performed independently.

3. The method according to claim 2 wherein the grooming of inbound and outbound traffic is performed free of tandem tying the first and second transport switches.

4. The method according to claim 1 further including configuring the at least one local switch to operate with the first and second transport switches.

5. The method according to claim 1 further including performing protocol switching at the at least one local switch.

6. The method according to claim 1 further including performing grooming at at least a third transport switch.

7. The method according to claim 1 wherein the first and second transport switches are at least one of the following:
wideband crossconnect switches, narrowband crossconnect switches, or broadband crossconnect switches.

8. The method according to claim 1 performed in a central office.

9. The method according to claim 1 performed in an electrical, optical, or wireless network.

10. A system for grooming network traffic in a digital cross connect, comprising:
a first transport switch that grooms inbound traffic for at least one local switch; and
a second transport switch that grooms outbound traffic for the at least one local switch.

11. The system according to claim 10 wherein the first transport switch and second transport switch operate substantially free of intermachine tandem ties.

12. The system according to claim 10 wherein the local switch is configured to operate with the first and second transport switches.

13. The system according to claim 10 wherein the local switch is a protocol switch.

14. The system according to claim 10 further including a third transport switch that grooms other traffic.

15. The system according to claim 10 wherein the transport switches are at least one of the following: a wideband crossconnect switch, narrowband crossconnect switch, or broadband crossconnect switch.

16. The system according to claim 10 used in a central office.

17. The system according to claim 10 used in an electrical, optical or wireless network.

18. A system for grooming network traffic in a digital cross connect, comprising:
means for grooming inbound traffic at a first transport switch for at least one local switch; and
means for grooming outbound traffic at a second transport switch for the at least one local switch, the first transport switch being distinct from the second transport switch.
